(19) United States
(12) Patent Application Publication
(10) Pub. No.: US 2008/0290009 A1
(43) Pub. Date: Nov. 27, 2008

(54) Water Softening Device

(76) Inventor: Kenneth A. Koch, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 12/124,260

(22) Filed: May 21, 2008

Related U.S. Application Data
(60) Provisional application No. 60/939,886, filed on May 24, 2007.

(51) Int. Cl. B01D 35/157

(52) U.S. Cl. 210/88

(57) ABSTRACT

A water softening device comprises a salt chamber, a metering chamber, and a softening chamber. The salt chamber holds salt, while the metering chamber holds brine. The softening chamber holds water softening material, such as zeolite beads. An input is in fluid communication with the salt chamber for producing brine. The input may be coupled with a shower outlet or other structure. An output is in fluid communication with the softening chamber to communicate softened water from the system through a shower head or other device. The salt chamber and metering chamber may be positioned such that the salt chamber communicates brine upwardly into the metering chamber against the influence of gravity. The salt chamber may be positioned lateral to the softening chamber. The metering chamber may be substantially fluidly isolated from the softening chamber as water is communicated from the input to the softening chamber.

### PRIORITY

This applications claims priority from the disclosure of U.S. Provisional Patent Application Ser. No. 60/939,886, having the same title, filed on May 24, 2007, which is incorporated by reference herein.

### BACKGROUND

Some embodiments of the present invention relate to a device that may be coupled with a shower head to soften water before it exits the shower head. One exemplary device for softening water is disclosed in U.S. Pat. No. 6,521,132, entitled “Ion Exchange Water Softener and Method.” Another exemplary device for softening water is disclosed in U.S. Pat. No. 1,611,422, entitled “Process of Regenerating Zeolites.” While a variety of systems and methods have been made and used to soften water, it is believed that no one prior to the inventors has made or used a system as described herein.

### BRIEF DESCRIPTION OF THE DRAWINGS

The accompanying drawings incorporated in and forming a part of the specification illustrate several aspects of the present invention, and together with the description serve to explain the principles of the invention; it being understood, however, that this invention is not limited to the precise arrangements shown. In the drawings, like reference numerals refer to like elements in the several views. In the drawings:

FIG. 1 depicts a plan view of an exemplary water softening device;

FIG. 2 depicts a cross-sectional view of the water softening device of FIG. 1, taken along line 2-2 of FIG. 1; and

FIG. 3 depicts another cross-sectional view of the water softening device of FIG. 1, taken along line 3-3 of FIG. 2.

Reference will now be made in detail to various embodiments of the invention, examples of which are illustrated in the accompanying drawings. To the extent that specific dimensions are shown in the accompanying drawings, such dimensions should be regarded as merely illustrative and not limiting in any way. Accordingly, it will be appreciated that such dimensions may be varied in any suitable way.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the descriptions should be regarded as illustrative in nature and not restrictive.

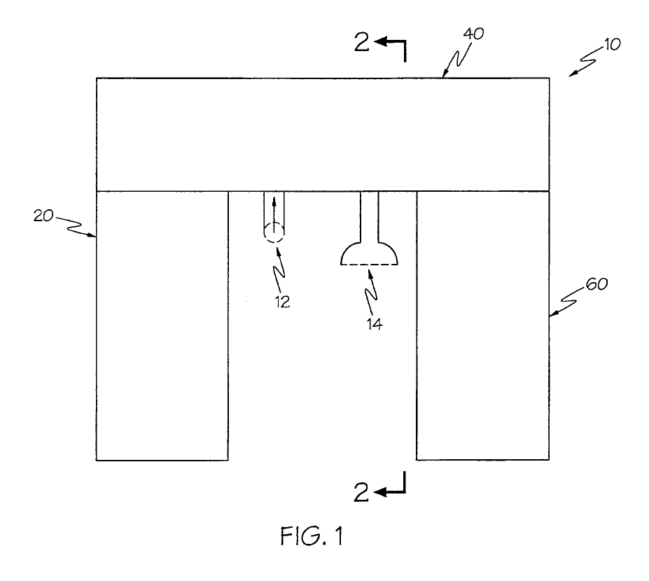

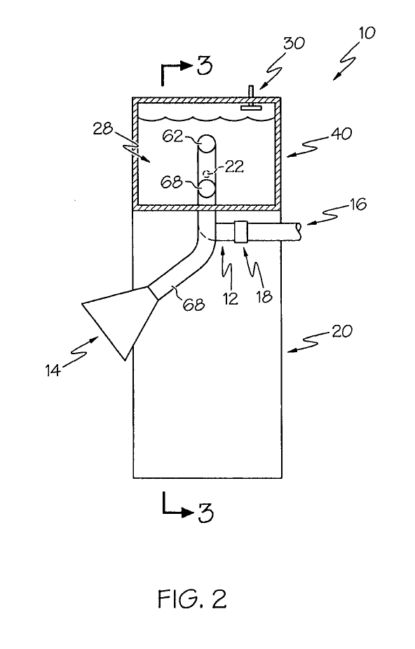

As shown in FIGS. 1-3, a merely exemplary water softening device (10) comprises a salt chamber (20), a metering chamber (40), and a softening chamber (60), each of which will be described in greater detail below. Water softening device further comprises an input conduit (12) and a shower head (14). Input conduit (12) is configured to couple with an outlet pipe (16) via a coupling (18). In the present example, outlet pipe (16) comprises a shower pipe extending from a bathroom wall (not shown), though outlet pipe (16) may exist in a variety of other settings. Coupling (18) may comprise a threaded nut, a soldered joint, or any other structure(s) suitable for providing sealed fluid communication from outlet pipe (16) to input conduit (12). Shower head (14) comprises a conventional shower head, and is configured to output water that is cycled through water softening device (10). It will therefore be appreciated that water softening device (10) may be mounted in place of a conventional shower head in any suitable conventional shower. Furthermore, while the embodiment illustrated herein is in the context of a shower, it will be appreciated that water softening device (10) may alternatively be used in a variety of other settings, including but not limited to a bath faucet, a sink faucet, or any other location.

In the present example, input conduit (12) enters metering chamber (40) and branches off into two separate directions. In particular, a salt feed conduit (22) branches off from input conduit (12), toward salt chamber (20), as will be described in greater detail below. Input conduit (12) also provides a fluid path toward softening chamber (60), via a softening conduit (62), as will also be described in greater detail below. As shown, the inner diameter of softening conduit (62) is greater than the inner diameter of salt feed conduit (22). Accordingly, a majority of water communicated through input conduit (12) may be diverted toward softening chamber (60), with relatively less water being diverted toward salt chamber (20). Alternatively, any other suitable structures (e.g., variable control valves, etc.) or techniques may be used to provide more water to softening chamber (60) than to salt chamber (20). Such suitable alternative structures or techniques will be apparent to those of ordinary skill in the art in view of the teachings herein. In other versions, however, substantially the same amount of water may be provided to softening chamber (60) and salt chamber (20); or more water may be provided to salt chamber (20) than to softening chamber (60). Still other ways in which water from input conduit (12) may be diverted, including relative allocation amounts, will be apparent to those of ordinary skill in the art in view of the teachings herein.

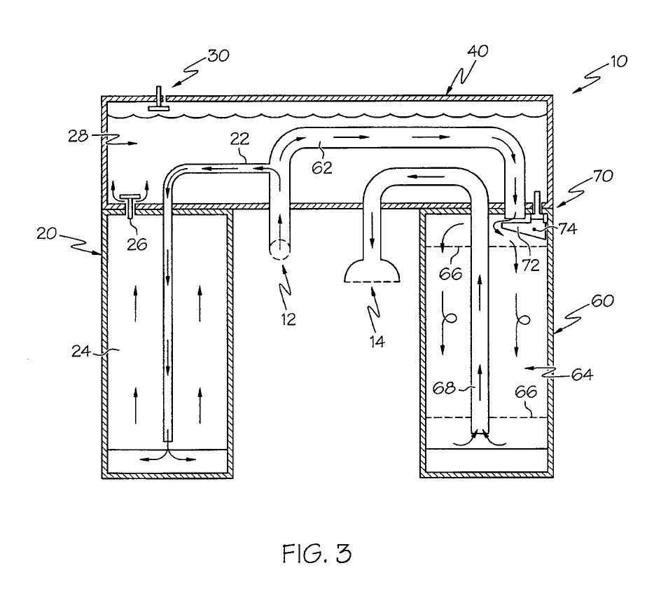

As shown in FIG. 3, softening conduit (62) extends partially into softening chamber (60), and is configured to communicate water into softening chamber (60). Softening chamber (60) of the present example comprises a plurality of zeolite beads (64), which are configured to strip dissolved calcium and magnesium ions, among other things, from water that is communicated into softening chamber (60) by softening conduit (62). Of course, any suitable alternative to zeolite beads may be used, including but not limited to any suitable ion exchange resin or other material(s). A strainer (66), such as a screen, is provided near the bottom of softening chamber (60) in this example, and is configured to prevent passage of zeolite beads (64). A softened water output conduit (68) extends from beneath strainer (66), up, through, and out of softening chamber (60), into and through metering chamber (40), then back out of metering chamber (40) to couple with shower head (14). Accordingly, water that is fed through input conduit (12) and into softening conduit (62) is softened by zeolite beads (64) as the water flows through softening chamber (60), and then exits water softening device (10) at shower head (14) via softened water conduit (68). An additional strainer (66) (e.g., a screen, etc.) is provided near the top of softening chamber (60) in this example. Of course, strainers (66) are optional, and may be substituted, supplemented, modified, rearranged, or omitted altogether as desired.

In the present example, a valve (70) is provided between softening chamber (60) and metering chamber (40). Valve (70) is configured to prevent the flow of water from softening chamber (60) to metering chamber (40), as well as the flow of water from metering chamber (40) to softening chamber (60), while water softening device (10) is in use (e.g., when water is being communicated through input conduit (12)). Valve (70) of the present example comprises an arm (72) and a pivot (74). In some versions, valve (70) is urged closed by hydrostatic pressure of water within a substantially full softening chamber (60). In some other versions, valve (70) is urged closed by hydrodynamic pressure induced by the flow of water out of softening conduit (62). By way of example only, softening conduit (62) and/or other components may be configured such that the hydrodynamic pressure induced by the flow of water out of softening conduit (62) is greater than the hydrostatic pressure of water or brine (28) within metering chamber (40). Operation of valve (70) may also be varied based on the length of arm (72) and/or the location of pivot (74). It will be appreciated that valve (70) as described herein is merely exemplary, and that valve (70) may be substituted, supplemented, or varied in any suitable way. By way of example only, valve (70) may alternatively lack arm (72) and/or pivot (74), may have any other suitable structures and features, and/or may operate under any other suitable principles or conditions.

As shown, metering chamber (40) is located above outlet pipe (16). It will be appreciated that such an arrangement may facilitate drainage of fluid from metering chamber (40) into softening chamber (60) or may provide other results. However, in alternative versions, metering chamber (40) and outlet pipe (16) may have any other suitable relationship. Furthermore, drainage of fluid from metering chamber (40) into softening chamber (60) may be facilitated in any suitable alternative way.

As noted above, a portion of water that is communicated through input conduit (12) is diverted to salt feed conduit (22). As shown, salt feed conduit (22) extends into the bottom of salt chamber (20). Salt chamber (20) contains salt (24), brine, or any other suitable substance. As water is communicated into salt chamber (20) via salt feed conduit (22) and fills salt chamber (20), the water dissolves salt (24) within salt chamber (20) to form a brine (28). As salt chamber (20) becomes full of this brine (28), the brine (28) flows into metering chamber (40). As shown, a one-way valve (26) is provided between salt chamber (20) and metering chamber (40) to prevent backflow of brine (28) from metering chamber (40) into salt chamber (20), such as during times when water softening device (10) is not in use. Of course, one-way valve (26) may be modified, substituted, or supplemented in any suitable way. In other versions, one-way valve (26) is omitted altogether, such that one or more openings are provided between salt chamber (20) and metering chamber (40) without any type of valve within or adjacent to such openings.

Metering chamber (40) of the present example includes a valve (30), which is located at the top of metering chamber (40), and which selectively provides a vent to atmosphere. Valve (30) in this example is a hydrostatic valve that will float and thereby close, though any other suitable type of valve may be used. In the present example, as metering chamber (40) fills with brine (28), valve (30) may be open to provide a vent for air to escape from metering chamber (40). When metering chamber (40) becomes full of brine (28) during use of water softening device (10), the pressure of brine (28) within metering chamber (40) closes valve (30). As noted above, valve (70) is also closed during use of water softening device (10). Accordingly, metering chamber (40) and valves (30, 70) may serve to trap a measured amount of brine (28) within metering chamber (40). Other ways in which brine (28) may be trapped within metering chamber (40) or otherwise metered within water softening device (10) will be apparent to those of ordinary skill in the art in view of the teachings herein.

When the supply of water from input conduit (12) is cut off (e.g., when a user is finished taking a shower and turns off the water, etc.), each of valves (30, 70) may open, which may allow brine (28) that was trapped in metering chamber (40) to flow or drain out of metering chamber (40) into softening chamber (60), such as by gravity. It will be appreciated that the flow of brine (28) from metering chamber (40) into softening chamber (60) may serve to recharge zeolite beads (64). At least a portion of residual water within softening chamber (60) may be forced out of softening chamber (60) through softened water conduit (68) and shower head (14) when brine (28) flows or drains from metering chamber (40) into softening chamber (60).

In one embodiment, at least a portion of softening chamber (60) is configured to be selectively coupled with metering chamber (40). For instance, softening chamber (60) may comprise a cap (not shown), cartridge (not shown), and/or other structure that is operable to screw onto, snap into, or otherwise removably engage with or relative to metering chamber (40). For instance, a cartridge may house zeolite beads (64) or some other substance(s). Accordingly, it will be appreciated that a cartridge may be replaced when zeolite beads (64) are spent and can no longer be effectively recharged by brine (28). Alternatively, a variety of types of cartridges may be provided, with each cartridge housing one or more substances selected to filter out one or more different types of substances from water. For instance, some cartridges may be designed to filter iron, chlorine, etc. from water. Furthermore, more than one type of cartridge may be coupled to water softening system (10) at a given time. It will also be appreciated that softening chamber (60) may be configured such that a replaceable cartridge does not need to include components such as valve (70). By way of example only, a cartridge may be configured such that it houses a portion of a softened water conduit (68) that is configured to selectively couple with another portion of a softened water conduit (68) that is integral with water softening device (10). In addition, a cartridge may be configured such that zeolite beads (64) contained therein cannot be replaced without destroying the cartridge, such that replacing the zeolite beads (64) of a water softening system (10) will require a new cartridge. Still other ways in which softening chamber (60) may be varied to provide replacement of zeolite beads (64) will be apparent to those of ordinary skill in the art in view of the teachings herein.

Similarly, at least a portion of salt chamber (20) may be configured to be selectively coupled with metering chamber (40). For instance, salt chamber (20) may comprise a replaceable cartridge (not shown) that houses salt (24). Such a cartridge may have any of the properties or be subject to any of the modification discussed above with respect to a cartridge for softening chamber (60). While some versions may permit conventional salt pellets to be used in salt chamber (60), other versions may not. For instance, salt (24) may comprise a specially formed regenerative salt. Alternatively, salt (24) may comprise sodium chloride (e.g., table salt, etc.), potassium chloride, or any other suitable substance(s), material(s), fluid(s), etc. Other variations of salt (24), including but not limited to substitutes and/or supplements for salt (24), will be apparent to those of ordinary skill in the art in view of the teachings herein. In addition, other ways in which salt chamber (60) may be varied to provide replacement of salt (24), to the extent that it is desired to provide replaceability of salt (24), will be apparent to those of ordinary skill in the art in view of the teachings herein.

As will be appreciated by those of ordinary skill in the art, the entry/exit interfaces of input conduit (12), salt feed conduit (22), softening conduit (62) and output conduit (68) into and out of metering chamber (40), salt chamber (20), and softening chamber (60) may include any suitable gaskets, o-rings, or other structures to prevent undesired leakage at such interfaces.

It will also be appreciated that, while salt chamber (20), metering chamber (40), and softening chamber (60) are shown as being generally rectangular in shape and cross-section, salt chamber (20), metering chamber (40), and softening chamber (60) may have any other suitable shapes or cross-sections (e.g., tubular, round, etc.). Furthermore, suitable internal volumes or capacities for salt chamber (20), metering chamber (40), and softening chamber (60), and suitable relationships between such volumes, will be apparent to those of ordinary skill in the art in view of the teachings herein.

In some other versions, water softening device (10) comprises a selective bypass (not shown) that a user may operate to bypass softening chamber (60). For instance, such a bypass may comprise a selectively activated fluid connection between input conduit (12) and shower head (14), with whatever appropriate valve(s) or other structure(s) that may be desired to selectively prevent the flow of water through water softening device (10). Such a bypass may be activated by a mechanical feature (e.g., knob, handle, etc.), an electromechanical feature (e.g., thin film switch, button, etc.), or any other suitable type of feature.

In still other versions, water softening device (10) comprises one or more hose attachment features (not shown). For instance, a hose attachment feature may be provided to permit softened water to be communicated from water softening device (10) through an external hose. Alternatively, a hose attachment feature may be provided to permit fluid to be delivered to water softening device (10) via a hose. Such a fluid may comprise water, brine, or any other suitable fluid.

While at least a portion of each of input conduit (12), salt feed conduit (22), softening conduit (62), and softened water conduit (68) is shown as being located within the interior of water softening device (10), it will be appreciated that a substantial portion, if not the entirety, of each of input conduit (12), salt feed conduit (22), softening conduit (62), and softened water conduit (68) may be located exterior to water softening device (10) or elsewhere. Other suitable ways in which each of input conduit (12), salt feed conduit (22), softening conduit (62), and softened water conduit (68) may be located, positioned, oriented, arranged, or configured will be apparent to those of ordinary skill in the art in view of the teachings herein.

In one embodiment, the weight of water softening device (10) is supported by outlet pipe (16) at coupling (18). In another embodiment, one or more brackets (not shown) are used to mount water softening device (10) to a wall, ceiling, or other structure. Other suitable structures and techniques for mounting or otherwise supporting water softening device (10) will be apparent to those of ordinary skill in the art in view of the teachings herein.

While water softening device (10) has been described herein as usable to soften water, it will be appreciated that water softening device (10) (or variations thereof) may alternatively be used to perform any other type of process or filtration of water. Similarly, it will be appreciated that water softening device (10) (or variations thereof) may alternatively be used with any fluid other than water for any alternative purposes. Accordingly, it is contemplated that water softening device (10) (and variations thereof) may be used in a variety of other contexts, and it is not intended to be necessarily limited to the uses explicitly described herein.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of whatever claims recite the invention, and is understood not to be limited to the details of structure and operation shown and described in the description.

What is claimed is:

1. A water softening system, comprising:
(a) a salt chamber, wherein the salt chamber is configured to hold salt;
(b) a metering chamber in fluid communication with the salt chamber, wherein the metering chamber is configured to hold brine, wherein the salt chamber and the metering chamber are positioned such that the salt chamber communicates brine upwardly into the metering chamber against the influence of gravity;
(c) a softening chamber in fluid communication with the metering chamber, wherein the softening chamber is configured to hold water softening material;
(d) an input in fluid communication with the salt chamber, wherein the input is configured to communicate water to the salt chamber, wherein the salt chamber is configured to mix the water with the salt; and
(e) an output in fluid communication with the softening chamber, wherein the output is configured to communicate softened water from the softening chamber.

2. The water softening system of claim 1, wherein the input is further in fluid communication with the softening chamber, wherein the softening chamber is configured to mix the water from the input with the water softening material to produce the softened water.

3. The water softening system of claim 2, wherein the input comprises a pipe, wherein the pipe comprises a first portion extending toward the salt chamber and a second portion extending toward the softening chamber.

4. The water softening system of claim 3, wherein the first portion has a first inner diameter, wherein the second portion has a second inner diameter, wherein the second inner diameter is greater than the first inner diameter.

5. The water softening system of claim 3, wherein the softening chamber has a top region and a bottom region, wherein the second portion of the input pipe terminates within the top region of the softening chamber.

6. The water softening system of claim 5, wherein the output comprises a pipe, wherein the pipe terminates within the bottom region of the softening chamber.

7. The water softening system of claim 1, wherein the water softening material comprises zeolite beads.

8. The water softening system of claim 1, wherein the softening chamber comprises a top portion and a bottom portion, wherein the metering chamber is positioned at the top portion of the softening chamber to permit fluid to flow from the metering chamber to the softening chamber under the influence of gravity.

9. The water softening system of claim 8, wherein the salt chamber comprises a top portion and a bottom portion, wherein the metering chamber is further positioned at the top portion of the salt chamber.

10. The water softening system of claim 1, wherein the metering chamber has a vent.

11. The water softening system of claim 10, wherein the metering chamber further comprises a valve configured to selectively close the vent.

12. The water softening system of claim 11, wherein the valve comprises a hydrostatic valve.

13. The water softening system of claim 1, further comprising:
(a) a fluid path between the metering chamber and the softening chamber to provide fluid communication from the metering chamber to the softening chamber; and
(b) a valve configured to selectively block the fluid path.

14. The water softening system of claim 13, wherein the valve comprises a hydrodynamic valve.

15. The water softening system of claim 14, wherein the valve comprises an arm and a pivot, wherein the arm is positioned proximate to an outlet of the input, wherein the valve is configured to partially rotate about the pivot when water flows through the outlet and against the arm, wherein the valve is configured to substantially block the fluid path when the valve is partially rotated about the pivot under the influence of water flowing through the outlet and against the arm.

16. The water softening system of claim 1, wherein the salt chamber further comprises a replaceable cartridge holding the salt.

17. The water softening system of claim 1, wherein the softening chamber further comprises a replaceable cartridge holding the water softening material.

18. The water softening system of claim 1, further comprising a shower head coupled with the output.

19. A water softening system, comprising:
(a) a salt chamber, wherein the salt chamber is configured to hold salt;
(b) an input in fluid communication with the salt chamber, wherein the input is configured to communicate water to the salt chamber, wherein the salt chamber is configured to mix the water with the salt to produce brine;
(c) a softening chamber, wherein the softening chamber is configured to hold water softening material, wherein the softening chamber is configured to receive brine produced in the salt chamber to recharge the water softening material, wherein at least a portion of the salt chamber is positioned lateral to at least a portion of the softening chamber;
(d) a metering chamber in fluid communication with both the salt chamber and the softening chamber, wherein the metering chamber is configured to hold brine communicated from the salt chamber and selectively communicate the brine to the softening chamber, wherein at least a portion of the metering chamber is positioned above at least a portion of the softening chamber; and
(e) an output in fluid communication with the softening chamber, wherein the output is configured to communicate softened water from the softening chamber.

20. A water softening system, comprising:
(a) a salt chamber, wherein the salt chamber is configured to hold salt;
(b) a metering chamber in fluid communication with the salt chamber, wherein the metering chamber is configured to hold brine;
(c) a softening chamber in fluid communication with the metering chamber, wherein the softening chamber is configured to hold water softening material;
(d) an input in fluid communication with the salt chamber, wherein the input is configured to communicate water to the salt chamber, wherein the salt chamber is configured to mix the water with the salt to produce the brine, wherein the input is in further fluid communication with the softening chamber, wherein the input is configured to communicate water to the softening chamber to produce softened water, wherein the metering chamber is substantially fluidly isolated from the softening chamber as water is communicated from the input to the softening chamber; and
(e) an output in fluid communication with the softening chamber, wherein the output is configured to communicate softened water from the softening chamber.
